(19) United States
(12) Patent Application Publication
(10) Pub. No.: US 2025/0223921 A1
(43) Pub. Date: Jul. 10, 2025

(54) Gas Turbine Generator Set and Mobile Power Generation Equipment

(71) Applicant: YANTAI JEREH PETROLEUM EQUIPMENT & TECHNOLOGIES CO., LTD., Yantai (CN)

(72) Inventors: Ting ZHANG, Yantai (CN); Wanchun ZHA, Yantai (CN); Jianglei ZOU, Yantai (CN); Qiong WU, Yantai (CN); Ning FENG, Yantai (CN); Yichao MU, Yantai (CN)

(73) Assignee: YANTAI JEREH PETROLEUM EQUIPMENT & TECHNOLOGIES CO., LTD., Yantai (CN)

(21) Appl. No.: 19/091,430

(22) Filed: Mar. 26, 2025

Related U.S. Application Data
(63) Continuation-in-part of application No. PCT/CN2022/085722, filed on Apr. 8, 2022.

(30) Foreign Application Priority Data
Mar. 9, 2022 (CN) 202220506085.0

(51) Int. Cl. F02C 6/00; F02C 7/055; F02C 7/06; F02C 7/18; F02C 7/22; F02C 7/36

(52) U.S. Cl. CPC F02C 6/00; F02C 7/055; F02C 7/06; F02C 7/18; F02C 7/22; F02C 7/36; F05D 2220/76; F05D 2260/232

(57) ABSTRACT

Disclosed are a gas turbine generator set and mobile power generation equipment. The gas turbine generator set includes a gas turbine, a generator, and an equipment cabin. The gas turbine is arranged inside the equipment cabin. The generator is connected to the gas turbine for generating electric power. The generator may be arranged outside the equipment cabin, so that a heat dissipation load of the equipment cabin is reduced. As such, difficulty in designing an efficient heat dissipation and cooling scheme for the gas turbine inside the equipment cabin is reduced. The solution also facilitates convenient maintenance of the generator without opening the equipment cabin or entering the equipment cabin.

### CROSS-REFERENCE TO RELATED APPLICATIONS

The application is based on and claims the benefit of priority to PCT Application No. PCT/CN2022/085722, filed on Apr. 8, 2022, which is based on and claims the benefit of priority to Chinese Patent Application No. 202220506085.0, filed with the China National Intellectual Property Administration on Mar. 9, 2022 and entitled “GAS TURBINE GENERATOR SET AND MOBILE POWER GENERATION EQUIPMENT”, which are incorporated in their entireties herein by reference.

### TECHNICAL FIELD

The disclosure relates to the technical field of power generation, particularly in-vehicle mobile emergency power generation, and specifically to a gas turbine generator set and mobile power generation equipment.

### BACKGROUND

In modern society, power takes a vital role in our production and living. Generally, the power required for our production and living is supplied by a complete system composed of power stations and power grids. However, the above system composed of fixed power stations and power grids cannot supply the power to production and living in some special cases, for example, when the above system is damaged by natural disasters, etc., or a project is to be constructed in a region not covered by the power grids. In these cases, to satisfy the demand on power for the production and living in time, high-power emergency power generation equipment has to be applied for power generation.

In addition, for some important scenarios, such as large-scale conferences and exhibitions or project construction sites, emergency power generation equipment is required as backup. During black start of large power stations, frequency modulation and voltage regulation in big cities, etc., emergency power generation equipment is also required to supply high temporary power.

A diesel generator set, a type of traditional emergency power generation equipment, has single unit power of 2 MW-3 MW without exceeding a particular weight limit (the weight limit generally indicates road weight capacity requirements), and thus cannot satisfy the above emergency power demand.

A gas turbine generator set can overcome the above deficiencies of the diesel generator set. The reason lies in that a gas turbine has higher power density. A weight and an outline size of the gas turbine generator set are merely ½-⅓ of those of a conventional diesel generator set in a case of outputting identical power, while the power of the gas turbine generator set can reach 6 MW-10 MW or even higher while satisfying road transportation weight requirements.

But an existing gas turbine generator set is also defective. For example, although noises transmitted to the outside are lowered by placing the gas turbine and a generator in a box, a high heat dissipation load is caused in a space inside the box.

### SUMMARY

In a first aspect, the disclosure relates to a gas turbine generator set. The gas turbine generator set includes a gas turbine, a generator, and an equipment cabin; where the gas turbine is arranged inside the equipment cabin, the generator is connected to the gas turbine positioned inside the equipment cabin, and used for generating power driven by the gas turbine.

In some implementation solutions, a coupling or a gear box is arranged between the gas turbine and the generator, and used for connecting the gas turbine and the generator.

In some implementation solutions, a cabin wall of the equipment cabin is provided with a first opening, and the first opening is provided with an air filter; and the gas turbine generator set is provided with an air intake pipe, the first end of the air intake pipe is arranged at an air intake passage of the gas turbine, and the second end of the air intake pipe is in communication with the air filter arranged at the first opening.

In some implementation solutions, the air filter arranged at the first opening is arranged at the top of the equipment cabin.

In some implementation solutions, a cabin wall of the equipment cabin is provided with a second opening, the second opening is provided with an air filter, and the second opening is used for inputting air outside the equipment cabin into the equipment cabin.

In some implementation solutions, the cabin wall of the equipment cabin is provided with a third opening, and the exhaust port of a gas turbine is orientated towards the third opening, and spaced apart from the third opening.

In some implementation solutions, the gas turbine generator set further includes an exhaust pipe, where the exhaust pipe is connected to the third opening at an outer side of the third opening, and a muffling structure is arranged in the exhaust pipe.

In some implementation solutions, the gas turbine generator set includes a first fuel container and/or a second fuel container, where the first fuel container stores a liquid fuel, and the second fuel container stores gas fuel; and fuel used for combustion in a combustion chamber of the gas turbine includes the liquid fuel introduced from the first fuel container and/or the gas fuel introduced from the second fuel container.

In some implementation solutions, the gas turbine generator set further includes a ventilation mechanism, where the ventilation mechanism is arranged at the generator, and used for driving air at the generator to circulate.

In a second aspect, the disclosure relates to mobile power generation equipment. The mobile power generation equipment includes a carrier and the above gas turbine generator set.

### BRIEF DESCRIPTION OF THE DRAWINGS

The accompanying drawings herein are incorporated in the description as a constituent part of the description. The example drawings illustrate embodiments conforming to the disclosure, and serve to explain the principles of the disclosure along with the description.

To describe the technical solutions in the embodiments of the disclosure or in the prior art more clearly, the accompanying drawings for describing the embodiments or the prior art will be briefly described below. Those having ordinary skill in the art can also derive other accompanying drawings from these accompanying drawings without creative efforts.

FIG. 1 shows a structure of a gas turbine generator set in an embodiment of the disclosure;

FIG. 2 is a schematic diagram of an exhaust port of a gas turbine in the gas turbine generator set shown in FIG. 1 during exhausting;

FIG. 3 shows another example structure of a gas turbine generator set in an embodiment of the disclosure;

FIG. 4 shows example additional components at a lubrication oil heat exchanger; and

FIG. 5 shows an example flow of lubrication oil through various components.

In the figures:
10 and 310—equipment cabin; 20—gas turbine; 30—generator; 11—air filter; 12—air filter; 21—air intake pipe; and 22—exhaust pipe; 311 and 411—fan; 320, 420, and 520—lubrication oil heat exchanger; 421 and 521—air filter; 422—inertial separator; 420—heat exchanger; 423—fire damper; 523—lubrication oil (or lubricant) tank; 524—lubrication pump; and 525—lubrication temperature control valve; 522—lubrication point.

### DETAILED DESCRIPTION

To make the objectives, technical solutions, and advantages in the embodiments of the disclosure clearer, the technical solutions in the embodiments of the disclosure are clearly and completely described below with reference to the accompanying drawings in the embodiments of the disclosure. Apparently, the embodiments described are some embodiments rather than all embodiments of the disclosure. Based on the embodiments of the disclosure, all other embodiments derived by those of ordinary skill in the art without creative efforts fall within the scope of protection of the disclosure.

Embodiments of a gas turbine generator set and mobile power generation equipment provided by the disclosure are described below in conjunction with the accompanying drawings.

### (1) The Embodiment of the Gas Turbine Generator Set

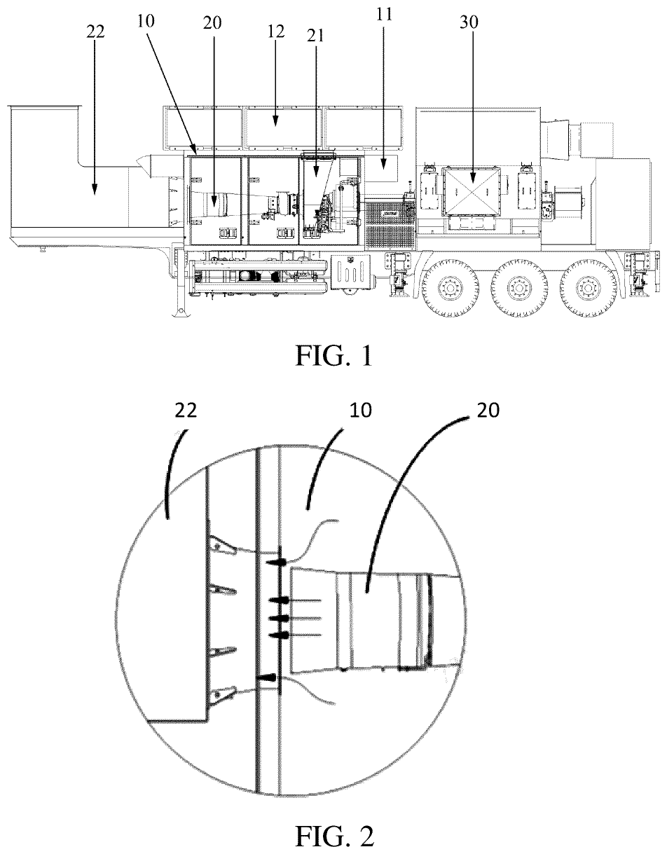

With reference to FIG. 1, the gas turbine generator set according to the embodiment includes an equipment cabin 10, a gas turbine 20, and a generator 30.

The equipment cabin 10 is used for accommodating main equipment (including the gas turbine 20 and related equipment) of the gas turbine generator set except the generator 30. The equipment (mainly the gas turbine 20) generates high noises during operation. By mounting the equipment inside the equipment cabin 10, noises transmitted to the outside of the equipment cabin 10 can be lowered, and noise disturbance to surrounding people by the gas turbine generator set can be relieved.

In the embodiment, the gas turbine 20 is arranged inside the equipment cabin 10. The generator 30 is connected to the gas turbine 20 positioned inside the equipment cabin 10, and is used for generating power when driven by the gas turbine 20. Specifically, a coupling or a gear box is arranged between the generator 30 and the gas turbine 20. The coupling or the gear box penetrates the equipment cabin 10, one end of the coupling or the gear box is positioned inside the equipment cabin 10 to be connected to the gas turbine 20, and the other end thereof is positioned outside the equipment cabin 10 to be connected to the generator 30. Thus, the generator 30 is connected to the gas turbine 20 through the coupling or the gear box. An output shaft of the gas turbine 20 rotates during operation of the gas turbine 20. The rotation of the output shaft is transmitted through the coupling or the gear box, so as to drive moving components inside the generator 30 for power generation.

The gas turbine 20 and the generator 30 are core components of the gas turbine generator set. For the gas turbine 20 and the generator 30, the noises are mainly sourced from the gas turbine 20, and the noises generated by the generator 30 are lower. Thus, a noise level outside the equipment cabin 10 can be significantly lowered and relieved by arranging the gas turbine 20 inside the equipment cabin 10. The noise level outside the equipment cabin 10 will not be obviously increased by arranging the generator 30 outside the equipment cabin 10 instead of inside the equipment cabin 10. Accordingly, with the above solution of arranging the gas turbine 20 and the generator 30 inside and outside the equipment cabin 10 respectively, a relatively low noise level outside the equipment cabin 10 can be maintained during operation.

The gas turbine 20 and other components arranged inside the equipment cabin 10 generate heat during operation, and the heat is transferred into the equipment cabin 10 at first. For the equipment cabin 10, it is necessary to transfer the heat from the inside to the outside in time, preventing the heat from being accumulated continuously inside the equipment cabin 10. Otherwise, the operation of the gas turbine 20 and other components or equipment will be affected after a temperature inside the equipment cabin 10 is increased continuously. Thus, the equipment cabin 10 has a particular heat dissipation load, or more precisely, a large heat dissipation load. In the embodiment, the generator 30 is arranged outside the equipment cabin 10 instead of inside the equipment cabin 10. Thus, the heat generated by the generator 30 during operation is directly dissipated and transferred to the outside without being transferred into the equipment cabin 10, and the heat dissipation load of the equipment cabin 10 is not increased. In this way, a heat dissipation pressure of the equipment cabin 10 can be relieved, the equipment cabin 10 can better maintain its internal temperature at a proper level, and the gas turbine 20 and other components or equipment inside the equipment cabin 10 can be in more desirable operation states.

Also, compared with an existing gas turbine generator set in which a generator 30 is arranged inside an equipment cabin 10, the equipment cabin 10 of the gas turbine generator set according to the embodiment has a lower heat dissipation load, it is easier to design a heat dissipation and cooling solution for the gas turbine 20 and other components or equipment inside the equipment cabin 10, and a solution with higher heat dissipation and cooling efficiency can be designed for the gas turbine 20 and other components or equipment inside the equipment cabin 10. Accordingly, the gas turbine 20 and other components or equipment can have a better heat dissipation and cooling effect.

In a case where the generator 30 is arranged outside the equipment cabin 10, the generator 30 is more convenient to maintain without opening the equipment cabin 10 or entering the equipment cabin 10 in the process.

The generator 30 generates heat during operation, and the heat generated can be dissipated through natural circulation between the generator 30 and outside air. A ventilation mechanism may be arranged at the generator 30 to accelerate air circulation at the generator 30. Accordingly, the heat can be taken away from the generator 30 more rapidly, and heat dissipation efficiency of the generator 30 can be improved. Specifically, the ventilation mechanism may be an independent fan device, or a rotary mechanism connected to the moving components inside the generator, so as to be driven by the moving components inside the generator. The rotary mechanism acts on air at the generator 30 when rotated under a driving action, so as to accelerate the air circulation in the region.

The gas turbine 20 needs air suction and exhaust during operation. In the embodiment, the gas turbine generator set is provided with an air intake pipe 21, where the air intake pipe 21 is used for supplying intake air required for operation to the gas turbine 20. Specifically, a cabin wall of the equipment cabin 10 is provided with a first opening, an air filter 12 is connected to the first opening, and the air filter 12 is in communication with the outside air. The first end of the air intake pipe 21 is arranged at an air intake passage of the gas turbine 20, and the second end of the air intake pipe 21 is in communication with the air filter 12 arranged at the first opening. During operation of the gas turbine 20, a suction force is generated at the air intake passage of the gas turbine 20. Under an action of the suction force, the outside air around the air filter 12 is sucked to the first end of the air intake pipe 21 through the air filter 12 and the air intake pipe 21, and enters the air intake passage of the gas turbine 20. Thus, the intake air demand of the gas turbine 20 is satisfied.

Specifically, the air filter 12 arranged at the first opening can filter the air introduced into the air intake passage of the gas turbine 20. With such an arrangement, a quality of the air entering the air intake passage of the gas turbine 20 can be ensured, and impurities are prevented from entering the air intake passage of the gas turbine 20. Thus, a desirable operation state of the gas turbine 20 is maintained, and disturbance to normal operation of the gas turbine 20 or damage to the gas turbine 20 caused by the impurities is avoided.

Preferably, the air filter 12 is positioned at the top of the equipment cabin 10. The top of the equipment cabin 10 is away from the ground, and the second end of the air intake pipe 21 is arranged at the top of the equipment cabin 10. Thus, dust, impurities, etc. on the ground are prevented from entering the air intake pipe 21, and the quality of the air entering the air intake pipe 21 is improved. Accordingly, the normal operation of the gas turbine 20 is ensured, and the probability that the gas turbine 20 is disturbed or damaged by other objects entering the air intake passage is reduced.

As shown in FIG. 1, the cabin wall of the equipment cabin 10 is provided with a second opening, the second opening is provided with an air filter 11, and the second opening is used for inputting air outside the equipment cabin 10 into the equipment cabin 10. In FIG. 1, the air filter 11 is specifically arranged at one side, positioned outside the equipment cabin 10, of the second opening. In other embodiments, the air filter 11 or may be arranged at one side, positioned inside the equipment cabin 10, of the second opening. The outside air entering the equipment cabin 10 via the second opening is different from the air entering the equipment cabin 10 via the first opening. The outside air entering the equipment cabin 10 via the second opening is used for cooling the heat generated by the gas turbine 20 and other components or equipment inside the equipment cabin 10 during operation.

With continued reference to FIG. 1 and in conjunction with FIG. 2, the cabin wall of the equipment cabin 10 is provided with a third opening, and the exhaust port of a gas turbine 20 is orientated towards the third opening, and spaced apart from the third opening. Via the third opening, after discharged from the exhaust port of the gas turbine, exhaust gas generated by the gas turbine 20 during operation can be further discharged to the outside from the equipment cabin 10. Also, the exhaust port of the gas turbine 20 is spaced apart from the third opening, so that the exhaust port of the gas turbine 20 is in communication with a space inside the equipment cabin 10. When the gas turbine 20 discharges the gas to the outside, a flow field generated by the gas discharged from the exhaust port of the gas turbine 20 can affect and act on the air inside the equipment cabin 10. Specifically, as shown in FIG. 2, a negative pressure is formed in a region near the third opening just outside the equipment cabin 10. Under an action of the negative pressure, the air inside the equipment cabin 10 is sucked and discharged to the outside from the third opening. In this way, the air inside the equipment cabin 10 can be mixed with the exhaust gas (with a high temperature) discharged from the exhaust port of the gas turbine 20 at the third opening, so that the temperature of the gas discharged to the outside from the third opening can be reduced, and an adverse effect of the discharged gas having the high temperature on surrounding people, objects, or environment can be reduced or avoided. Moreover, the negative pressure can also act on the second opening, so that the outside air can enter the equipment cabin 10 via the second opening to cool the gas turbine 20 and other components or equipment inside the equipment cabin 10. Thus, the second opening is not required to be provided with a special-purpose fan, etc. that are used for introducing the outside air into the equipment cabin 10.

The gas turbine generator set further includes an exhaust pipe 22, the exhaust pipe 22 is connected to the third opening at an outer side of the third opening, and a muffling structure is arranged in the exhaust pipe 22. The exhaust pipe 22 is connected to the third opening on the cabin wall of the equipment cabin 10, and can guide the gas discharged from the gas turbine 20 during operation to flow in the exhaust pipe 22 and to be discharged to the outside at the exhaust end of the exhaust pipe 22. It can be understood that in consideration of an extremely-high temperature of the gas discharged from the gas turbine 20 during operation, the gas discharged from the gas turbine 20 can be discharged into the outside air at a high position or a position away from the surrounding people through the exhaust pipe 22, so as to avoid danger to the surrounding people or objects.

The muffling structure is arranged in the exhaust pipe 22 to reduce a sound of the airflow in the exhaust pipe 22 and transmit lower noises generated by the gas turbine 20 during operation to the outside.

A muffler provided at the exhaust end, an external muffling device mounted on the exhaust pipe 22, can further lower the noises based on the muffling structure arranged in the exhaust pipe 22.

The gas turbine generator set further includes a fuel container, and the fuel container is used for supplying fuel required to operation to the gas turbine 20. In the embodiment, the fuel container includes a first fuel container and a second fuel container, the first fuel container stores a liquid fuel, and the second fuel container stores gas fuel. Fuel used for combustion in a combustion chamber of the gas turbine includes the liquid fuel introduced from the first fuel container and the gas fuel introduced from the second fuel container. In other words, in the embodiment, the gas turbine 20 is configured to operate depending on both the liquid fuel and the gas fuel.

In consideration of safety, the second fuel container may be an external container. In other words, the second fuel container is connected to the gas turbine 20 during operation of the gas turbine 20. When the gas turbine 20 is in a non-operation state, the second fuel container is not connected to the gas turbine 20, and may even be stored separately, instead of being placed on the gas turbine generator set.

Certainly, the gas turbine 20 or may be configured to operate depending on the liquid fuel or the gas fuel only. In this case, the fuel container includes the above first fuel container or the above second fuel container only.

To summarize the above, the gas turbine generator set according to the embodiment of the disclosure includes the equipment cabin 10, the gas turbine 20, and the generator 30; where the gas turbine 20 is arranged inside the equipment cabin 10, and the equipment cabin 10 can reduce transmission of the sound generated by the gas turbine 20 during operation to the outside, so that the noise level of the gas turbine generator set can be lowered. The generator 30 is arranged outside the equipment cabin 10, so that the heat generated by the generator 30 during operation can be directly exchanged with an external medium outside the equipment cabin 10 for heat dissipation and cooling. It is not required to take the heat to the outside of the equipment cabin 10 through a heat exchange and cooling structure inside the equipment cabin 10 by transferring the heat into the equipment cabin 10 at first. With the above arrangement, first, the heat dissipation load of the equipment cabin 10 can be reduced, and the equipment cabin 10 can better maintain its internal temperature at the proper level, so that more heat is dissipated from the gas turbine 20 and other components or equipment inside the equipment cabin 10, and their desirable operation states are maintained. Second, in a case of a lower heat dissipation load of the equipment cabin 10, it is less difficult to design the heat dissipation and cooling solution for the gas turbine 20 and other components or equipment inside the equipment cabin 10, the solution with higher heat dissipation and cooling efficiency and a better heat dissipation and cooling effect can be designed, and thus the gas turbine 20 and other components or equipment can have a better heat dissipation and cooling effect. Finally, when the generator 30 is arranged outside the equipment cabin 10, the generator 30 is more convenient to maintain without opening the equipment cabin 10 or entering the equipment cabin 10 in the process.

### (2) The Embodiment of the Mobile Power Generation Equipment

In the embodiment, the mobile power generation equipment includes a carrier and the gas turbine generator set described in the embodiment of the above gas turbine generator set.

Specifically, as shown in FIG. 1, the carrier in the embodiment is a vehicle or another type of mobile transportation tool capable of carrying objects. When used as the carrier, the vehicle may be specifically a self-propelled vehicle having a power unit or a trailer having no power unit.

In some example implementations, a cabin ventilation and lubrication cooling system may be included and configured in the turbine-based power generation system above. The lubrication cooling system may be used to cool lubrication oil (or lubricant) that circulates through the various components of the turbine engine and the electric generator. The lubrication cooling system may correspondingly include a lubrication oil heat exchanger. The lubrication oil flowing through the heat exchanger may be cooled by air flow. The lubricating oil heat exchanger in the lubrication system may be arranged on the cabin ventilation and cooling path, specifically, it can be arranged on any wall panel of the cabin or arranged inside the turbine engine cabin above.

The lubrication oil heat exchanger may be provided with a channel for cooling air to pass through, and the cooling air can pass through the heat exchanger through the channel to cool the lubrication oil being circulated through the heat exchanger. In addition, the cooling air can also take away heat generated by the gas turbine and other components in the cabin.

In some example implementations, referred to as Configuration Scheme 1, at least one fan can be arranged in the cabin to generate cooling airflow, and the fan can be arranged at the end of the cooling airflow direction. The lubricating oil heat exchanger can be arranged on a wall panel of the cabin. The operation of the fan forms a negative pressure in the cabin, and then the cooling air flows from outside of the cabin into the cabin through the cooling channel of the lubrication oil heat exchanger at the location where the lubricating oil heat exchanger is installed. When the air flows through the heat exchanger, the heat of the lubricating oil in the heat exchanger will be taken away, so as to achieve the effect of cooling the lubricating oil. Further cooling air will flow through the cabin, taking away the heat generated by the gas turbine and other components in the cabin, and finally be discharged from the cabin through the fan disposed at the end of the airflow to achieve the cooling function of the cabin.

In some other example implementations, referred to as Configuration Scheme 2, the fan can alternatively be disposed upstream of the cooling airflow. In other words, the cooling airflow is first generated by the fan, and then the cooling air enters the cabin and passes through the cooling channel of the lubricating oil heat exchanger, and continues to flow through the gas turbine and other components in the cabin, takes away the heat generated by the cabin components, and finally is discharged from the air circulation exhaust port in the cabin. The lubricating oil heat exchanger in this scheme can be disposed inside the cabin or on the cabin wall (inlet or exhaust port).

In some other example implementations, referred to as Configuration Scheme 3, and as described above in relation to FIG. 2, a negative pressure may be generated by the high-speed outward flow of the exhaust gas of the gas turbine. In particular, when the turbine engine is running, the Venturi effect generated by the high exhaust flow rate by the turbine engine exhaust can also form a negative pressure region, so that the air outside the cabin flows through the heat exchanger into the cabin and drawn to the negative pressure region. This effect, again, is explained in FIG. 2 where the high speed exhaust from the exhaust end 20 of the gas turbine engine with the exit port close to the cabin wall flow towards outside of the cabin wall to the exhaust pipe 22 through an opening on the cabin wall, thereby creating a low pressure region just outside of the cabin wall, which draws the air 10 in the cabin through the opening of the cabin wall with the flow of the gas turbine engine exhaust. Cool air may then replenish the air inside the cabin, creating an inward flow through the heat exchanger for cooling the lubrication oil.

In the example implementations above, the lubricating oil heat exchanger need not be inside the equipment cabin. It only needs to be near the air circulation intake port of the cabin such that the cool air can flow through the intake port into the equipment cabin followed by flowing through the lubricating oil heat exchanger, or flow through the lubricating oil heat exchanger followed by flowing into the intake port into the equipment cabin. The intake port and the exit port need not be at opposite walls of the equipment cabin. For example, the exit port may be on an end wall or side wall of the equipment bin. Likewise, the intake port may be on an end wall or side wall of the equipment cabin, as long as the air flow from the intake port to the exit port pass both the lubricating oil heat exchanger and the turbine engine.

In the various example implementations above, the location of the heat exchanger can be further equipped with inertial separators, filter elements, and fire dampers. The inertial separators and the filter elements may be used to process the air entering the cabin to prevent moisture (e.g., rainwater) and dust particles from entering the cabin, thereby reducing pollution and damages to the cabin components and improving the stability and life of the unit. The main function of the fire damper is to cut off the air passage between the cabin and the outside when a fire occurs inside the cabin, preventing outside air and oxygen from entering the cabin, thereby assisting in quenching the fire. In this way, when the fire-fighting system installed in the cabin releases the fire-extinguishing agent, it can achieve a better fire-fighting result.

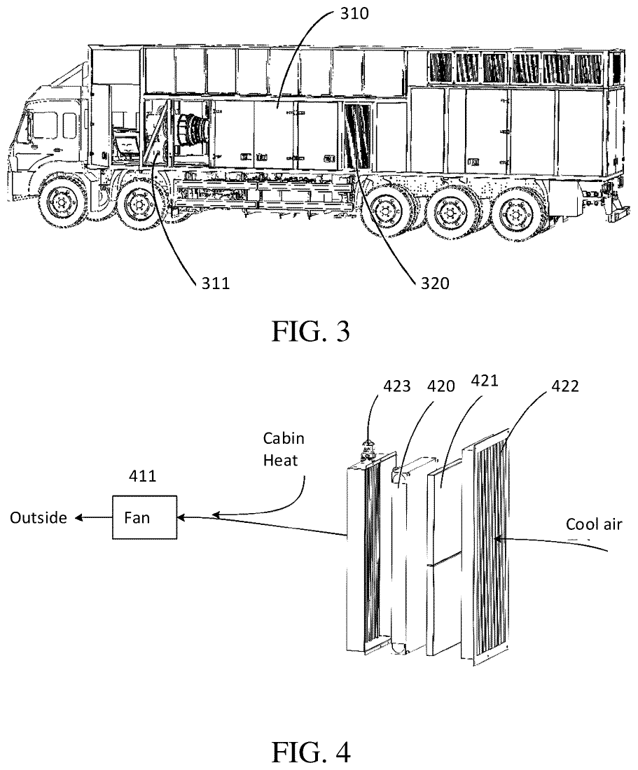

The Configuration Scheme 1 above is further illustrated in detail in FIG. 3. As shown in FIG. 3, the gas turbine generator set is equipped with a silent cabin 310 and a lubrication system, wherein the heat exchanger 320 in the lubrication system is arranged on the cabin wall of 310, and a fan 311 for cabin cooling and ventilation can be arranged inside or outside the silent cabin 310. It may be used to discharge the heat radiated during the operation of the gas turbine to the outside of the cabin. Atmospheric air enters the silent cabin through the location of the lubrication system heat exchanger, flows through the location of the gas turbine, and takes away the heat radiated by it via air flow, and finally discharges the air heated up by the turbine engine to the outside of the cabin.

The fire dampers, air filters, inertial separators, and other related components described above can be configured upstream or downstream of the air flow path, that is, in front of or behind the lubricating oil heat exchanger for filtering the cooling air in the cabin and improving the fire-fighting effect. FIG. 4 illustrates one such example. In FIG. 4, the cooling air flow passes through the inertial separator 422, the air filter 421, the lubricating oil heat exchanger 420 and the fire damper 423 in sequence (as an example). After the cooling air enters the cabin, the heat in the cabin is discharged out of the cabin through the action of the fan 411 or as induced by the negative pressure generated by the gas turbine and the exhaust system in Configuration Scheme 3 above, thereby achieving the purpose and effect of heat dissipation for the lubricating oil and the cabin.

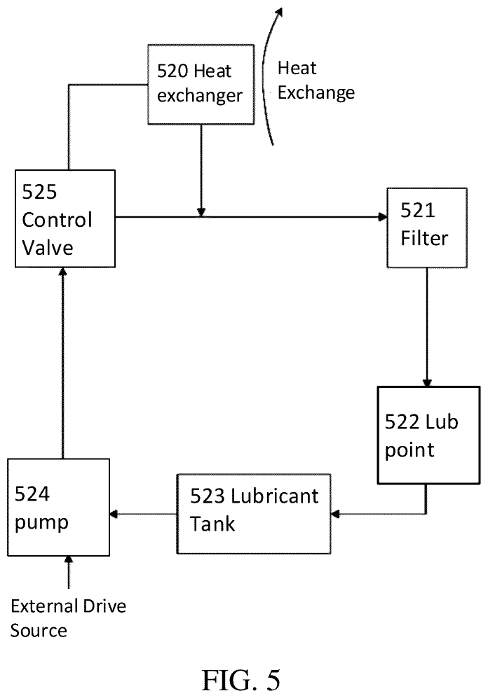

FIG. 5 further illustrates a block diagram for the lubrication system above. As shown in FIG. 5, the lubrication system may include a lubricating oil heat exchanger 520, filter(s) 521, lubrication point 522 (the components being lubricated), lubrication oil (or lubricant) tank 523, lubricating oil pump 524, and temperature control valve 525. The lubricating oil pump 524 may be driven by an external driving power source 526 (such as a gas turbine auxiliary gearbox or an electric motor, a gearbox power take-off, etc.), and the lubricating oil in the oil tank 523 may be first pumped to the temperature control valve 525, where the temperature control valve determines whether to let the lubrication oil enter the lubricating oil heat exchanger 520 for cooling according to a temperature of the lubricating oil. If the temperature of the lubricating oil is high enough (e.g., over a threshold temperature), the valve may open to allow the lubrication to flow through the lubricating oil heat exchanger 520, and the lubricating oil in the heat exchanger may then be cooled by the cooling air as described above, and is then circulated to the lubrication point 522 (gas turbine, gearbox, generator, etc.) through the filter 521 for lubrication, and finally return to the oil tank 523.

In the various example implementations above, the cabin ventilation and lubricating oil heat dissipation are centralized and integrated, which can simplify the structural design complexity of the entire generator set. It reduces the power consumption of the motor and improves the power generation efficiency of the whole system. At the same time, it has also greatly improved in weight and size, making it more suitable for the realization of mobile power supply.

The mobile power generation equipment according to the embodiment of the disclosure includes the gas turbine generator set described in the embodiment of the above gas turbine generator set, and has the same beneficial effects as those in the above gas turbine generator set, which will not be repeated.

It should be noted that the relationship terms herein such as “first” and “second” are merely used to differentiate one entity or operation from another entity or operation without necessarily requiring or implying any such an actual relationship or order between these entities or operations. Moreover, the terms “comprise”, “include”, “encompass”, or their any other variations are intended to cover the non-exclusive inclusion. Thus, a process, method, article, or apparatus including a series of elements not only includes those elements, but also includes other elements that are not explicitly listed, or further includes elements inherent to such a process, method, article, or apparatus. Without more restrictions, the elements defined by the phrase “comprise a . . . ” or “include a . . . ” do not exclude the existence of other identical elements in the process, method, article, or apparatus including the elements.

What are described above are merely the particular embodiments of the disclosure, through which those skilled in the art can understand or practice the disclosure. Various modifications to these embodiments will be apparent to those skilled in the art, and the general principles defined herein can be implemented in other embodiments without departing from the spirit or scope of the disclosure. Thus, the disclosure is not limited to these embodiments illustrated herein, but conforms to the broadest scope consistent with the principles and novel features applied for herein.

What is claimed is:

1. A gas turbine generator set, comprising:
a gas turbine;
an electric generator; and
an equipment cabin,
wherein the gas turbine is arranged inside the equipment cabin and the electric generator is connected to the gas turbine positioned inside the equipment cabin, and is used for generating power driven by the gas turbine.

2. The gas turbine generator set according to claim 1, wherein a coupling or a gear box is arranged between the gas turbine and the electric generator, and the coupling or the gear box is used for connecting the gas turbine and the electric generator.

3. The gas turbine generator set according to claim 1, wherein:
a cabin wall of the equipment cabin is provided with a first opening, and the first opening is provided with an air filter; and
the gas turbine generator set is provided with an air intake pipe, a first end of the air intake pipe is arranged at an air intake passage of the gas turbine, a second end of the air intake pipe is in communication with the air filter arranged at the first opening.

4. The gas turbine generator set according to claim 3, wherein the electric generator is arranged outside the equipment cabin.

5. The gas turbine generator set according to claim 1, wherein a cabin wall of the equipment cabin is provided with a second opening, the second opening is provided with an air filter, and the second opening is used for drawing air outside the equipment cabin into the equipment cabin.

6. The gas turbine generator set according to claim 1, wherein a cabin wall of the equipment cabin is provided with a third opening, and an exhaust port of the gas turbine is orientated towards the third opening, and spaced apart from the third opening.

7. The gas turbine generator set according to claim 6, further comprising an exhaust pipe, wherein the exhaust pipe is connected to the third opening at an outer side of the third opening, and a muffling structure is arranged in the exhaust pipe.

8. The gas turbine generator set according to claim 1, further comprising a first fuel container and/or a second fuel container, wherein:
the first fuel container stores liquid fuel, and the second fuel container stores gas fuel; and
a fuel used for combustion in a combustion chamber of the gas turbine comprises the liquid fuel introduced from the first fuel container and/or the gas fuel introduced from the second fuel container.

9. The gas turbine generator set according to claim 1, further comprising a ventilation mechanism, wherein the ventilation mechanism is arranged at the electric generator, and used for driving cooling air at the electric generator to circulate.

10. Mobile power generation equipment, comprising a carrier and the gas turbine generator set according to claim 1.

11. The gas turbine generator set according to claim 1, further comprising an air circulation system, the air circulation system comprising:
an air intake port through a first wall of the equipment cabin;
an air drawing mechanism disposed near a second wall of the equipment cabin; and
an air exit port through the second wall for the air drawing mechanism to draw cool air from outside of the equipment cabin through the air intake port, around the gas turbine, and through the air exit port to outside of the equipment cabin.

12. The gas turbine generator set according to claim 11, further comprising a lubrication oil heat exchanger disposed by the air intake port of the equipment cabin, wherein the cool air entering the air intake port and as drawn by the air drawing mechanism passes through the lubrication oil heat exchanger before passing around the gas turbine in the equipment cabin.

13. The gas turbine generator set according to claim 12, further comprising an inertia separator disposed at the air intake port before the lubrication oil heat exchanger in a direction of a flow of the cool air.

14. The gas turbine generator set according to claim 13, further comprising an air filter disposed by the air intake port but after the inertia separator in the direction of the flow of the cool air.

15. The gas turbine generator set according to claim 12, further comprising a fire damper disposed near the air intake port but after the lubrication oil heat exchanger in a direction of a flow of the cool air.

16. The gas turbine generator set according to claim 11, where the air drawing mechanism comprises a fan.

17. The gas turbine generator set according to claim 11, wherein the air drawing mechanism comprises an exhaust opening of the gas turbine being arranged at the air exit port which also function as a gas turbine exhaust port, wherein a high-speed exhaust from the exhaust opening of the gas turbine flowing outside of the equipment cabin through the air exit port generates a negative pressure near the air exit port, thereby drawing the cool air from outside of the equipment cabin through the air intake port, around the gas turbine, and through the air exit port to outside of the equipment cabin.

18. The gas turbine generator set according to claim 1, further comprising an air circulation system, the air circulation system comprising:
an air intake port through a first wall of the equipment cabin;
an air drawing mechanism disposed at the air intake port for drawing cool air from outside into the equipment cabin through the air intake port; and
an air exit port through a second wall for the cool air drawn by the air drawing mechanism to exit to outside of the equipment cabin after passing around the gas turbine.

19. The gas turbine generator set according to claim 18, further comprising a lubrication oil heat exchanger disposed in the equipment cabin by the air intake port, wherein the cool air entering the air intake port and as drawn by the air drawing mechanism pass through the lubrication oil heat exchanger before passing around the gas turbine.

20. The gas turbine generator set according to claim 19, wherein the air drawing mechanism comprises a fan.
